(19) United States
(12) Patent Application Publication
(10) Pub. No.: US 2006/0099328 A1
(43) Pub. Date: May 11, 2006

(54) Creating layers in thin-film structures

(76) Inventors: Michael Stuart Waite, Cheshire (GB); Adrian Paul Burden, Singapore (SG); Warren Lee, Berkshire (GB); Richard Alan Tuck, Berkshire (GB)

Correspondence Address: BARNES & THORNBURG, LLP, P.O. BOX 2786, CHICAGO, IL, 60690-2786, US

(21) Appl. No.: 10/529,099

(22) PCT Filed: Sep. 24, 2003
(86) PCT No.: PCT/EP03/50656

§ 371 Date: Sep. 26, 2005

(30) Foreign Application Priority Data
Sep. 26, 2002 (GB) 0222360.0

(51) Int. Cl. B05D 5/12

(52) U.S. Cl. 427/58; 427/162; 427/157; 427/226; 427/180; 427/372.2

(57) ABSTRACT

A layer of a material is created in a thin-film structure by coating a substrate (14) in one pass with an ink having a major, fugitive component (13) and at least one minor, non-fugitive component (12) and treating the ink to expel the major component (13) to leave the layer (15) of material. The layer (15) may bean electrically insulating layer having a thickness in the range 0.5 to 10 micrometres, with the ink containing non-fugitive colloidal ceramic nanoparticles having a size in the range 10 to 100 nanometres. The layer (15) may be a process control. layer, such as an etch stop layer or barrier layer. The layer (15) may be an optically emissive layer or a layer of predetermined electrical conductivity.

This invention relates to the creation of layers of materials in thin-film structures, and to devices using such structures.

Displays and other devices are typically created by depositing materials on substrates. For large-area displays and in particular plasma display panels and field emission displays, the substrate is usually glass. For other devices such as detectors and photovoltaic solar cells, the substrate may be glass, silicon, refractory ceramics like alumina, metal or coated metal. Because such substrates are compatible with curing the deposited materials at relatively high temperatures (of the order of 500° C.), there is an opportunity to deposit a wet layer of material and then heat it to drive off any solvents whilst reacting any precursors to leave a cured and adherent functional layer.

Different devices have different requirements for layers. However, there is often a need for thin continuous layers to be deposited uniformly and evenly over a substrate or underlying device structure. A non-exhaustive list of examples of such layers includes barrier layers, process control layers e.g. etch stops, resistive layers, insulating layers, conductive layers, transparent layers of defined refractive index (e.g. antireflection coatings), and phosphor-containing layers.

Such layers may exist in a variety of devices including plasma display panels, field emission displays, photovoltaic solar cells, humidity sensors, gas sensors, temperature sensors, integrated circuits, and opto-electronic components.

It occurs to us that an ideal technique for depositing these materials would be screen printing, because any required patterning can be defined by the stencil, meaning that material is only deposited where required down to feature sizes as small as 35 micrometer. In addition, such a deposition technique is relatively inexpensive, fast and compatible with the large area substrates that are useful for displays and other broad area or multi-component devices. However, screen printing generally only works well with paste-like materials that are very viscous and leave relatively thick and rough layers, usually because there is a high particle loading in the ink. Layers with such characteristics may not be desired, especially when building a multi-layered structure requiring smooth layers, thin layers or low surface area and pore-free layers.

Embodiments of the present invention aim to provide inks for use in creating materials useful for a range of devices that may be printed by means of silk screen, offset lithography and other techniques.

Preferred embodiments of the present invention aim to provide cost-effective materials that may be used in displays and other devices that include (amongst others): plasma display panels; field electron emission display panels; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; ozonisers; plasma reactors; photovoltaic solar cells; waveguides; gas sensors; humidity sensors; temperature sensors; integrated circuits; and optoelectronic devices.

According to one aspect of the present invention, there is provided a method of creating a layer of electrically insulating material in a thin-film structure, the method comprising the steps of coating a substrate in one pass with an ink having a major, fugitive component and at least one minor, non-fugitive component and treating the ink to expel said major component to leave said layer of electrically insulating material, wherein said layer of electrically insulating material has a thickness in the range 0.5 to 10 micrometres, and said ink contains non-fugitive colloidal ceramic nanoparticles having a size in the range 10 to 100 nanometres.

As will be understood by those skilled in the art, the term “thin-film structure” as used herein means a device, element or component, active or passive, created from at least one layer of material but usually more, wherein the thickness of the or each layer is of the order of microns. Often, one or more layer is patterned to provide the function of the device. Sometimes, thin-film structures are regarded as requiring layers to be manufactured by vacuum-based deposition processes, but within the context of this specification, the or each layer may be formed by any suitable process.

Said nanoparticles may comprise one or more simple or compound oxide, containing cations of one or more element.

Said one or more element may be selected from the group comprising nitrides, oxynitrides, borates, silicates and phosphates.

Said ink may comprise an insulator precursor selected from the group comprising sols, organometallics and organic compounds containing non-metallic elements.

Said ink may comprise comprises an insulator precursor selected from the group comprising silica sol, polysiloxanes, silsequioxane polymers, β-chloroethylsilsesquioxane, hydrogensilsequioxane, acetoxysilsesquioxane and H3BO3.

In another aspect, the invention provides a method of creating a process control layer of a material in a thin-film structure, the method comprising the steps of coating a substrate in one pass with an ink having a major, fugitive component and at least one minor, non-fugitive component and treating the ink to expel said major component to leave said layer of material.

In the context of this specification, the term “process control layer” means a layer of material that is used to control a step of a manufacturing process—for example, an etch stop layer to protect certain parts of a device from an etching process applied to other parts of the device, or a barrier layer to prevent migration of elements from one layer to another in a device.

Said process control layer may be an etch stop layer.

Said etch stop layer may be adapted to resist fluorine chemistry etching.

Said ink may comprise a precursor for the process control layer which comprises at least one selected from the group comprising soluble compounds of the transition metals and sols of transition metal oxides.

Preferably, said transition metals have an atomic number in the range 21 to 30.

Preferably, said transition metal is chromium.

Preferably, said precursor comprises Cr(NO3)3.9H2O.

Said process control layer may be a barrier layer.

Said ink may comprise a precursor for said layer that is selected from the group comprising silica sol, alumina sols, titania sol, alumina sol plus a soluble phosphate, alumina sol plus a soluble organophosphate, polysiloxanes, silsequioxane polymers, β-chloroethylsilsesquioxane, hydrogensilsequloxane and acetoxysilsesquioxane.

In another aspect, the invention provides a method of creating an optically emissive layer of material in a thin-film structure, the method comprising the steps of coating a substrate in one pass with an ink having a major, fugitive component and at least one minor, non-fugitive component and treating the ink to expel said major component to leave said optically emissive layer of material.

Preferably, said optically emissive layer of material comprises a phosphor.

Preferably, said ink contains phosphor that has been added in dry, free-flowing powdered form, with a particle size in the range 1 to 10 micrometers.

Preferably, said particle size is in the range 3 to 5 micrometers.

Preferably, said ink comprises a soluble silica precursor comprising an oxide sol or organometallic complex soluble in the solvents used in the ink.

In a method according to any of the preceding aspects of the invention, the step of treating the ink may comprise subjecting the ink to ultra-violet radiation.

In another aspect, the invention provides a method of creating a layer of a material of predetermined electrical conductivity in a thin-film structure, the method comprising the steps of coating a substrate in one pass with an ink having a major, fugitive component and at least one minor, non-fugitive component and treating the ink to expel said major component to leave said layer of material, wherein said minor, non-fugitive component comprises one or more soluble ceramic precursor.

Preferably, said minor, non-fugitive component comprises colloidal ceramic nanoparticles having a size in the range 10 to 100 nanometres.

Preferably, said soluble ceramic precursor comprises one or more soluble compound of a metallic element that is a transition metal, rare earth element or main group element.

Preferably, said one or more soluble compound is selected from the group comprising La(NO3)3.6H2O, Sr(NO3)2.2H2O, Co(NO3)2.6H2O, Al(NO3)3.9H2O, Co(NO3)2.6H2O, Ni(NO3)2.6H₂O, In(NO3)3.6H₂O, Fe(NO3)3.6H₂O and AgNO3.

Preferably, said soluble ceramic precursor comprises one selected from the group comprising sols, organometallics and organic compounds containing non-metalic elements.

In a method according to any of the preceding aspects of the invention, the step of treating the ink may comprise pyrolising the ink.

Preferably, said ink is pyrolised at a temperature that is equal to or greater than 400° C.

The layer may be a continuous layer.

Preferably, the layer is substantially crack-free.

The layer may be of uniform composition.

The layer may be of a compound material.

The layer may have a composite structure.

Preferably, said ink contains at least one additive to control the rheology of the ink.

Said at least one additive may include at least one thickening agent.

Said thickening agent may comprise a fugitive soluble organic polymer.

Said fugitive soluble organic polymer may be selected from the group comprising poly(vinyl) alcohol; ethyl cellulose; hydroxyethyl cellulose; carboxymethyl cellulose; methylhydroxypropyl cellulose; hydroxypropyl cellulose; xanthan gum; and guar gum.

Preferably, said thickening agent comprises a non-fugitive material.

Said non-fugitive material may be selected from the group comprising fumed silica and Laponite.

Preferably, ink comprises at least one further additive to control further properties of the ink.

Preferably, said at least one further additive comprises at least one of an anti-foaming agent; a levelling agent, a wetting agent; a preservative; an air-release agent; a retarder; and a dispersing agent.

Said anti-foaming agent may be a fugitive material.

Said fugitive material may be selected from the group comprising butyl cellosolve; n-octanol emulsions of organic polymers and organic metal-compounds; and silicone-free defoaming substances in alkylbenezene.

Said anti-foaming agent may be a non-fugitive material.

Said non-fugitive material may comprise a silicone.

Preferably, said dispersing agent is selected from the group comprising poly(vinyl) alcohol; modified polyurethane in butylacetate, methoxypropylacetate and sec. butanol; modified polyacrylate in meythoxypropanol; polyethylene glycol mono(4-(1,1,3,3-tetramethylbutyl)phenyl)ether, and mineral oils.

Said dispersing agent may comprise a silicone oil.

Said at least one further additive may comprise at least one dispersing agent and at least one said minor component may have an affinity for that dispersing agent.

Preferably, said levelling agent is selected from the group comprising poly(vinyl) alcohol; fluorocarbon modified polyacrylate in sec. butanol; organically modified polysiloxane in isobutanol; and solvent-free modified polysiloxane.

Preferably, said wetting agent is selected from the group comprising unsaturated polyamide and acid ester salt in xylene, n-butanol and monpropylenegylcol; and alkylol amonium salt of a high molecular weight carboxylic acid in water.

Preferably, said preservative is selected from the group comprising phenols and formaldehydes.

Preferably, said air-release agent is selected from the group comprising silica particles and silicones.

Preferably, said retarder is selected from the group comprising 1,2-propanediol and terpineol.

In a method according to any of the preceding aspects of the invention, said coating step may comprise screen printing, ink-jet printing, offset lithography; pad printing; table coating and slot printing.

The invention extends to a thin-film structure that has been created by a method according to any of the preceding aspects of the invention.

The invention extends to an optical device incorporating such a thin-film structure.

The invention extends to a sensing device incorporating such a thin-film structure.

The invention extends to an electronic device incorporating such a thin-film structure.

The electronic device may be a field emission device.

The electronic device may comprise a plasma reactor, corona discharge device, silent discharge device, ozoniser, an electron source, electron gun, electron device, x-ray tube, vacuum gauge, gas filled device or ion thruster.

For a better understanding of the invention, and to show how embodiments of the same may be carried into effect, reference will now be made, by way of example, to the accompanying diagrammatic drawings, in which:

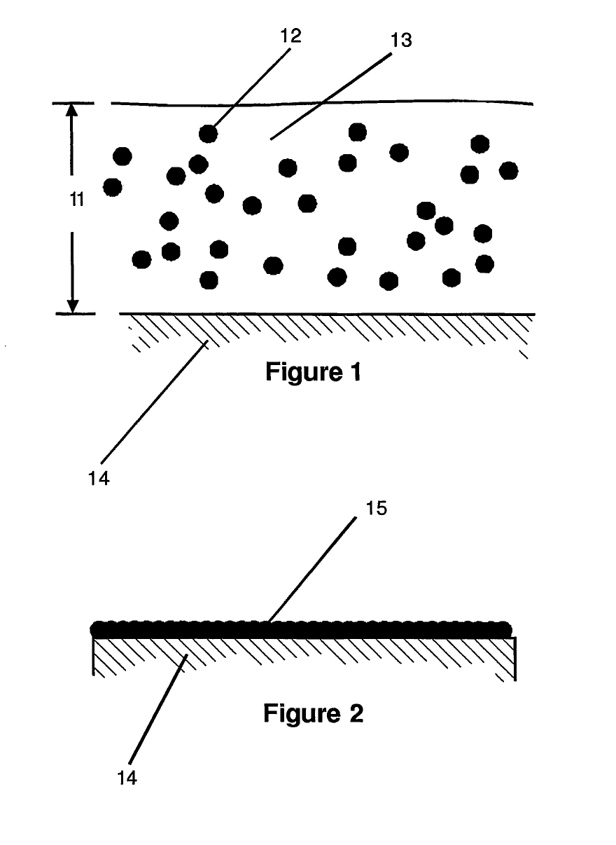

FIG. 1 illustrates a wet print;

FIG. 2 illustrates a dry print;

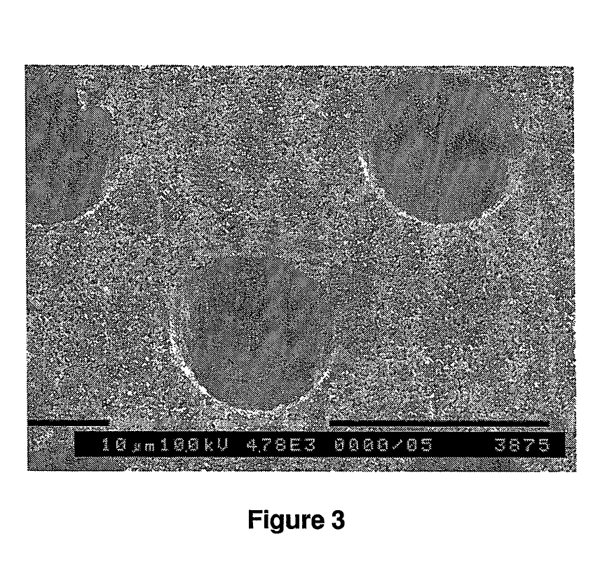

FIG. 3 is a photographic view of one example of a functional layer printed using an embodiment of an ink as described herein;

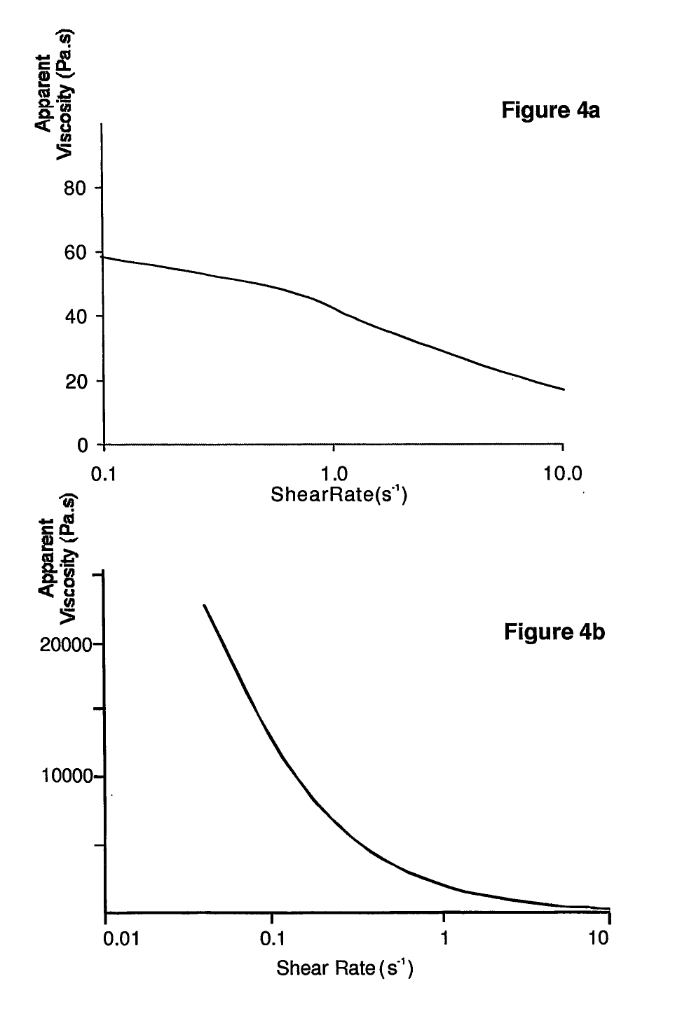

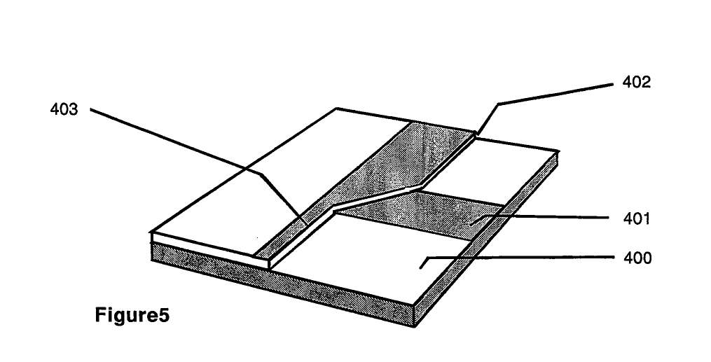

FIG. 4a shows rheometric data for a typical example of an embodiment of an ink described herein;

FIG. 4b shows similar rheometric data for a conventional proprietary high resolution thick film printing paste;

FIG. 5 shows a humidity sensor device fabricated using an embodiment of a material as disclosed herein;

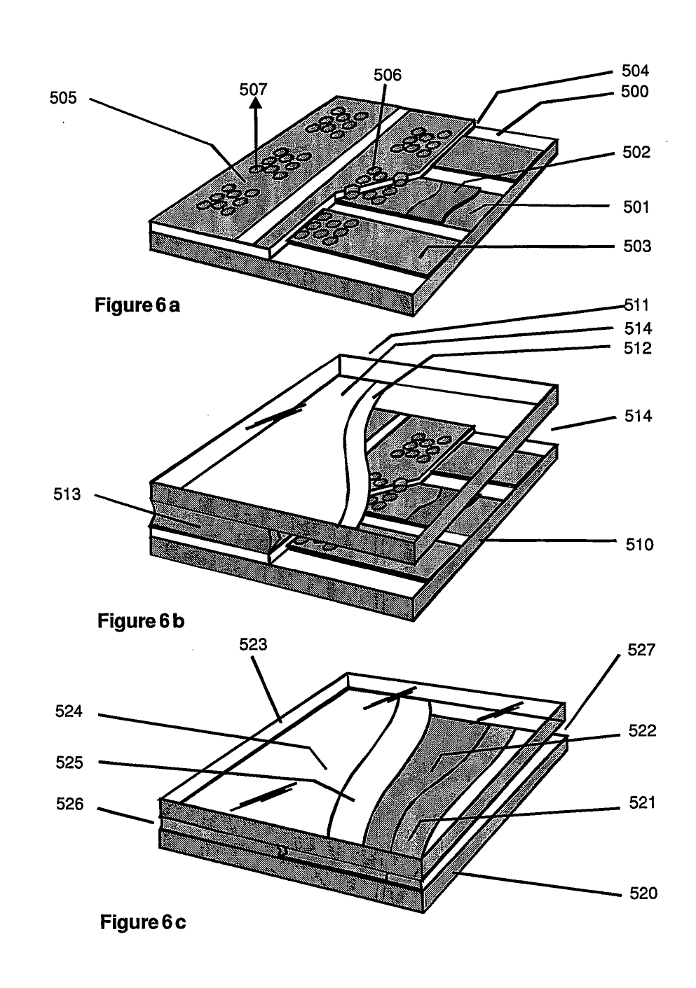

FIGS. 6a to 6c show respective examples of field-emitting devices using embodiments of materials as disclosed herein; and

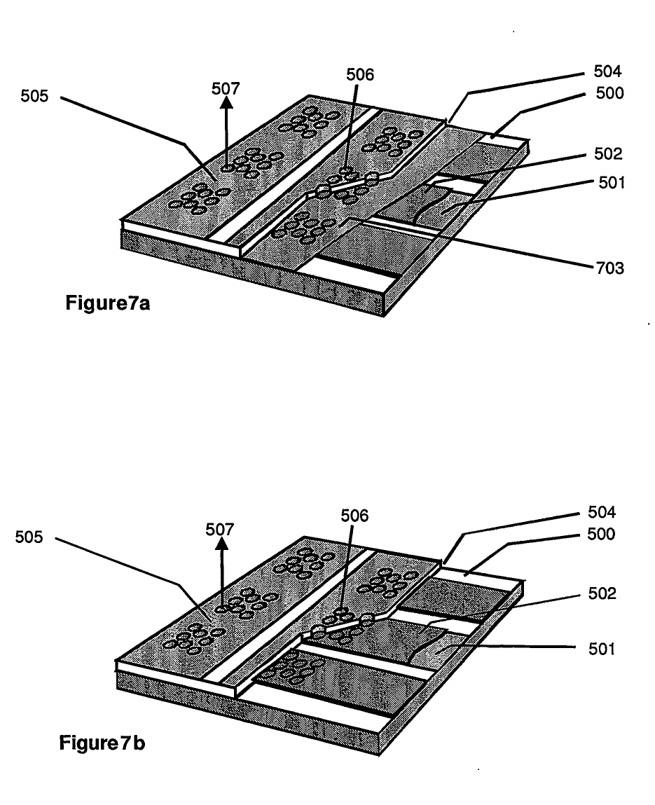

FIGS. 7a and 7b show alternative modifications of the example of FIG. 6a.

In the figures, like references denote like or corresponding parts.

The present invention may have many different aspects, and several examples of embodiments are given in the following description. It is to be appreciated that, where practical, features of one embodiment or example can be used with features of other embodiments or examples.

In order to print materials in displays and thick-film hybrid devices, the distinct trend in the art has been to emulate normal thick film circuit practice and use an ink in the form of a paste. By a “paste” we mean a malleable mixture wherein the particulate components comprise the majority of the formulation and wherein the theological, and hence printing, properties are controlled to a large degree by friction between those particulate components.

An alternative approach is to form a slurry of particles with a binding precursor that is viscous enough to enable a relatively high concentration of particulates but is still sufficiently liquid to be spin coated into a layer. Such a slurry provides the worst of both worlds, for it is too viscous for inkjet printing and too liquid to screen print. Therefore, a patterning is usually achieved by means of, for example, a photolithographic lift-off process that requires further processing steps and the provision of expensive capital equipment.

Preferred embodiments of the present invention provide methods of screen printing inks which meet a challenge which is illustrated in FIGS. 1 and 2. Using an ink viscosity much higher than previously proposed, particle clumping is much less of an issue, but with reference to FIG. 1, showing a wet-printed layer upon substrate 14, an as-deposited layer thickness 11 is now approximately 20 microns. Within the wet-printed layer is a low concentration of precursors or filler materials 12 suspended in a fugitive vehicle 13. On heat-treatment we require the wet-printed film to shrink controllably and, in the process, self-assemble good quality films 15 of a required composition and thickness as shown in FIG. 2.

In preferred aspects of the present invention, an ink contains at least the first two types of components listed below:
1. Chemical precursors including potentially reacting species to produce a binding or more continuous inorganic phase;
2. Fugitive components added to control Theological or other properties required during the application process;
   and optionally
3. Filler materials materials to bulk up the film, create a composite structure or further control the rheology of the coating, which can be of sub-micron or nanostructured dimensions. Exemplary fillers may comprise days or synthetic days or fumed silica.

Laponite, for example, is a synthetic clay with flakes of 25 nm mean diameter and has a profound effect on the viscosity of aqueous solutions by forming sol-gel solutions. Latexes may also be used to control viscosity. Many organic polymers, which can also be used, give a residue on thermal decomposition (often called “burn out” in the art). The residue may typically comprise carbon and/or salts and/or silica. Such additional materials may be removed after they have served their purpose during application and curing stages. Post-application treatment (usually heating) may also be necessary to convert precursor materials into final forms required for functional components of an insulator coating.

Filler materials are most conveniently added to ink ready formed from the desired material and with the desired particle size distribution. However, treatments such as thermal decomposition, chemical reduction or other reactions may be used to transform a precursor material into the form required in the final functional material.

For example, one type of liquid precursor for an insulating or optical control film is a liquid or soluble compound that will decompose to form a metal oxide on heating. There are many metal salts which will undergo such decomposition but which form particulate powdery deposits rather than the required film. A few, such as magnesium acetate, will form transparent coatings under certain conditions, such as spraying onto hot glass, but these tend to re-crystallise and to show poor adhesion. Organo-metallic complexes can give better results, but high volatility leads to difficulty in confining the coating to the required area, and processing is often made difficult by, for example, their being extremely inflammable or even pyrophoric. One range of practicable materials is to be found in sol-gels, which can be produced from a wide range of elements. These materials will readily form films by coalescence and drying from the liquid state, and are generally compatible with a wide range of other materials.

In the case of the organic-based approach to insulator formation, materials such as silicones (polysiloxanes) may be used. Equally, Arkles (U.S. Pat. No. 5,853,808) describes the use of silsequioxane polymers as precursors for the preparation of silica films. We have found these materials to be useful alternatives to sol-gel dispersions in the formulation of such inks. These materials are reversably soluble in a number of solvents, for example methoxypropanol. One polymer, β-chloroethylsilsesquioxane, has been found to be particularly useful. It is known that β-chloroethylsilsesquioxane and other silsesquioxanes such as hydrogensilsequioxane and acetoxysilsesquioxane yield ormosils (organically modified silicas) on heating or exposure to ultraviolet irradiation in the presence of ozone. Since, for example, some modified polysiloxanes are water soluble, the organic-based approach does not necessarily imply organic solvents.

In the case of the inorganic approach to insulating layers, sol-gel materials offer wide opportunities for easy variation of composition and are compatible with solvent mixtures such as: water; alcohol and water; and alcohol, acetone and water.

To deposit a functional layer, such inks often have two unusual features that make their formulation particularly challenging.
1. The vehicle component of the ink is fugitive, being decomposed and/or volatilised by subsequent during and heat treatment to leave the functional material or its precursor, and comprises a much greater proportion of the ink than is normal in other screen-printing arts—e.g. inks for decoration of ceramics or thick film hybrid circuits.
2. The proportion of solid particles in the ink can be extremely low by conventional screen printing ink standards, or zero.

The first of these features restricts the choice of materials that can be incorporated to control the Theological properties of the ink. Any fugitive polymer introduced to increase the viscosity has to decompose and volatilise at temperatures that will not damage the rest of the structure e.g. deformation of the glass substrate. In practice this is likely to entail removal at a temperature that is not greater than 450° C. To ease this process it is also desirable to use the minimum amount of any additive. For inks based on organic solvents, exemplary materials are ethyl cellulose, usually dissolved in terpineol, and methacrylate polymers dissolved in a variety of mixtures of ester and hydrocarbon solvents.

The insulator may then be introduced via suitable precursor. In the case of a silica-based insulating layer it can be introduced by means of, for example, a suitable substituted siloxane (silicone), silsesquioxanes or silica sol-gel. Clean and complete thermal decomposition of these polymers is achieved by around 350° C. to yield silica or an ormosil. The addition of fumed silica as a filler may be used to increase the thickness of the cured film.

Inks based on water not only avoid problems associated with the use of inflammable and harmful solvents, they allow the use of a wide range of water-based sol-gel materials for the formation of the insulator component of the emitter structure. The increase in viscosity required for printing can be achieved by the use of water soluble polymers such as poly(vinyl alcohol) or hydroxypropyl cellulose (HPC)—both are readily removed by thermal volatilisation. Poly(vinyl alcohol) or HPC have further advantages when used with sol-gel materials in that each can itself become incorporated (reacted) with the sol by condensation of the hydroxyl groups of the gel with those of the polymer side chains. This leads to a beneficial rise in viscosity of the ink allowing the use of reduced concentrations of polymer.

The control of rheology is also affected by the generally low or zero particle loading required in these inks. Whereas in most printing inks, the particle concentration is large enough to make a major contribution to the viscosity of the ink, in some versions of these inks, any effect of the particles on Theological properties is negligible and the theological properties of the ink are, in the main, those of the vehicle and precursor or vehicle, precursor and filler. This is of particular importance with inks for screen-printing, where a high particle loading helps to prevent the ink from bubbling as it is passed through the fine mesh of the printing screen. In the absence of this effect, these inks need an alternative mechanism to prevent bubbling during printing. One means is to incorporate an anti-foaming and/or air release agent into the ink. Polymer and ink additive manufacturers offer a variety of materials for this purpose such as the longer chain aliphatic alcohols or proprietary mineral oil type defoamants. Butyl cellosolve and n-octanol have been found to be effective with poly(vinyl alcohol), and n-Octanol is effective with hydroxypropyl cellulose. When used with sol-gels, the condensation of poly(vinyl alcohol) or hydroxypropyl cellulose side chains with the polymer induces a slight gelation of the solution which is highly advantageous as it increases the viscosity for a given amount of polymer. The gel also helps to eliminate any bubbling during screen printing.

Some polymers may also act as dispersants by both preventing any filler particles from flowing in the ink and by coating the filler particles leading to steric repulsion.

The ink may optionally contain: dispersing agents; a preservative; a retarder (to slow down the rate of drying of the ink); and/or a wetting agent to improve wetting of the ink on the substrate.

The material for printing is usually, but not necessarily, a single liquid phase. However, filler components may be dispersed using suitable surfactants in, for example, a mineral oil phase which is immiscible with the polymer and majority of solvents used.

Examples of ink formulations using the teachings of this document are described below.

To avoid repetition a number of key materials are defined below—all values given are typical and not absolute.

Hydroxypropyl cellulose A has an average molecular weight of 140000 determined by size exclusion chromatography.

Hydroxypropyl cellulose B has an average molecular weight of 370000 determined by size exclusion chromatography.

Poly(vinyl alcohol) C is 88% partially hydrolysed polyvinyl alcohol in 4% by volume aqueous solution at 20° C. The viscosity is 40 mPas.

Silicon dioxide precursor D is a solution of β-chloroethylsilsesquioxane in methoxypropanol.

### EXAMPLE 1

Applications of this example include a fluorine chemistry resisting etch stop and an inorganic insulating or barrier layer.

This example provides as an aspect of the invention a method of preparing ceramic printable films, preferably with a range of thickness from 10-300 nm, by application of a precursor ink which can be pyrolysed at temperatures equal to or greater than 400° C. to give a layer which has a low etch rate under the conditions used to etch PECVD silica layers. That is, it forms low volatility fluorides. The layer is preferably a substantially crack free, continuous layer of uniform composition. Such an etch stop layer may be applied as an oxide film by printing or a related process, e.g. doctor blade coating.

Suitable materials to act as etch stop are the elements and oxides of the transition metals, particularly those of atomic number 21 to 30, Sc to Zn. A preferred metal is Cr and its oxide, Cr₂O₃.

A suitable ink to create said layers comprises:
A: Soluble ceramic precursors composed of an oxide sol or a salt or organometallic complex soluble in the solvents used in the precursor
B: Polymer to control theological properties
C: Drying control agents
D: Dispersion agents
E: Volatile solvents which, together with components from B above, control rheology and which are lost in the preliminary drying stage.

The ink is prepared from combinations of one or more items from A to E above and mixed to obtain a homogeneous, transparent product. Typical processes are: mixing with the aid of ultrasonic or high shear blenders, triple roll mills, ball mills or blade mills. Vacuum or pressure filtration may be used if it is necessary to remove undispersed aggregates.

The ink may be applied to the substrate using techniques such as screen printing, inkjet printing, wire toll bar, doctor blade coating, spraying or spin coating. The preferred method is screen printing to give uniform layers with a wet thickness of 10 to 30 microns.

The fugitive solvents are removed by initial gradual drying on a hot plate, IR lamp drying or warm air flow. Ideal drying temperatures to remove solvent without cracking are in the range 25° C. to 130° C.

The film is then cured by firing under controlled temperature rise to plateau temperature in the range 400° C. to 900° C., depending on the material and the substrate softening temperature, to obtain the finished layer as a ceramic sheet bonded to the substrate.

One exemplary formulation for the preparation of a Cr₂O₃ film is as follows, although other combinations are also satisfactory.

Step 1: Preparation of Ink

2.06 g Cr(NO₃)₃.9H₂O is dissolved in 8.0 g propan-1:2-diol and 2 g H₂O. The solution is blended with 20 g of a polymer gel comprising 30 g hydroxypropylcelluloseB in 126 ml H₂O, 54 ml ethanol and 180 ml propan-1:2-diol. The viscosity and flow properties are adjusted with 10 g butoxyethanol and 1.4 g octanol.

Step 2: Screen Printing

The ink may be applied to the substrate using a patterned screen printing mask with, for example, a stainless steel 192 t.p.i mesh and 13 micrometer emulsion thickness. The mesh is ideally oriented at 45° to the frame axes.

Step 3: Drying and Firing

The coated substrates are dried on hot plates in dean room conditions, preferably in a laminar flow cabinet, at 65° C. for 20 minutes, followed by 20 minutes at 130° C. The warm substrates are transferred to an oven with a clean air atmosphere. The firing schedule is: 130° C. to 550° C. at 6° C. per minute, held at 2 hour at 550° C. and then slowly cooling to room temperature at 2 to 3° C. per minute.

### EXAMPLE 2

Applications of this example include an insulating layer for use as, for example, a spacer within a liquid crystal display, an insulator within a gas sensor or a gate insulator in a field emission display.

This example provides as an aspect of the invention a method of preparing thick ceramic printable films with a range of permittivity by application of a precursor ink which can be pyrolysed at temperatures equal to or greater than 400° C. to give a layer that is preferably up to 6 microns in thickness in a single print application. The layer is preferably a substantially crack free, continuous layer of uniform composition. It may be loaded with fumed silica.

A suitable ink to create such a layer comprises:
A: Colloidal ceramic nanoparticles of particle size 10 to 100 nm which may be composed of:
   A-1: simple or compound oxides, containing cations of one or more elements
   A-2: nitrides and oxynitrides
   A-3: borates, silicates or phosphates;
B: Soluble ceramic precursors composed of an oxide sol or a salt or organometallic complex soluble in the solvents used in the precursor;
C: Polymer to control Theological properties
D: Drying control agents
E: Dispersion agents
F: Volatile solvents which, together with components from C above, control rheology and which are lost in the preliminary drying stage.

The ink is prepared in the following manner:

The ink is formulated from combinations of one or more items from A to F above, together with such processes as are necessary to obtain a homogeneous, translucent product Typical processes are mixing with the aid of ultrasonic or high shear blenders, triple roll mills, ball mills or blade mills. If necessary this may be followed by vacuum or pressure filtration to remove undispersed aggregates.

The ink may be applied to the substrate using techniques such as screen printing, inkjet printing, wire roll bar, doctor blade coating, spraying or spin coating. The preferred method is screen printing to give uniform layers with a wet thickness of 10 to 30 microns.

The fugitive solvents are removed by initial gradual drying on a hot plate, IR lamp drying or warm air flow. Ideal drying temperatures to remove solvent without cracking are in the range 25° C. to 130° C.

The film is then cured by firing under controlled temperature rise to plateau temperature in the range 400° C. to 900° C., depending on the material and the substrate softening temperature, to obtain the finished layer as a ceramic sheet bonded to the substrate.

One exemplary formulation for the preparation of a 3 to 4 micrometer thick silica film is as follows although other combinations are also satisfactory.

Step 1: Preparation of the Ink:

3.0 g fumed silica of approximately 25 nm mean particle size is blended with 12.0 g silica sol containing 8.0 g SiO₂/100 g sol derived from the acid hydrolysis of 41.66 g tetraethyl orthosilicate in 97 g propan-2-ol with 11.14 g 3.0 v % HNO₃ in H₂O.

3.0 g Dimethylformamide is added as a dispersion aid and drying control agent, converting the runny silica/sol blend into a stiff, translucent gel.

21.0 g of a polymer gel is added, comprising 30 g hydroxypropyl celluloseB in 54 ml ethanol, 180 ml propan1:2 diol and 126 ml water.

15.0 g butoxyethanol and 2.1 g octanol are added and the blend stirred until it appears homogeneous and translucent to visual inspection, for example as a thin layer under low power microscope examination.

Step 2: Screen Printing

The ink may be applied to the substrate using a patternusing a patterned screen printing mask with, for example, a stainless steel 192 t.p.i mesh and 13 micrometer emulsion thickness. The mesh is ideally oriented at 45° to the frame axes.

Step 3: Drying and Firing

The coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. For glass substrates the firing schedule is: ˜130° C. to 550° C. at 6° C. per minute, held at 2 hour at 550° C. and then slowly cooling to room temperature at 2 to 3° C. per minute. Films produced to this heat treatment schedule have densities approximately 50% of that of the fully dense material. FIG. 3 shows a SEM image of such a layer with a 10 micrometer diameter via formed by reactive ion etching.

With more refractory substrates the maximum temperature may be increased and higher as-fired densities achieved. The local surface density may be increased by laser treatment or infra-red rapid thermal annealing to form an impermeable skin on the surface.

### EXAMPLE 3

This example includes include a formulation for the preparation of a boron doped silica insulating layer for application as, for example, a gate insulator in an opto-electronic device. Other combinations are also satisfactory.

Step 1: Preparation of the Ink:

2.95 g fumed silica of ca. 25 nm mean particle size is blended with 14.9 g silica sol containing 8.0 g SiO₂/100 g sol derived from the acid hydrolysis of 41.66 g tetraethyl orthosilicate in 97 g propan-2-ol with 11.14 g 3.0 v % HNO₃ in H₂O.

0.2 g H₃BO₃ is added in 3 g Dimethylformamide

19.0 g of a polymer gel is added, comprising 30 g hydroxypropyl cellulose B in 54 ml ethanol, 180 ml propan1:2 diol and 126 ml water.

7.5 g butoxyethanol and 1.7 g octanol are added and blend stirred until it appears homogeneous and translucent to visual inspection, e.g. as a thin layer under low power microscope examination.

Step 2: Screen Printing

The ink may be applied to the substrate using a patterned screen printing mask with, for example, a stainless steel 192 t.p.i mesh and 13 micrometer emulsion thickness. The mesh is ideally oriented at 45° to the frame axes.

Step 3: Drying and Firing

The coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. For glass substrates the firing schedule is: ˜130° C. to 550° C. at 6° C. per minute, held at 2 hour at 550° C. and then slowly cooling to room temperature at 2 to 3° C. per minute. Films produced to this heat treatment schedule have densities approximately 50% of that of the fully dense material.

With more refractory substrates the maximum temperature may be increased and higher as-fired densities achieved. The local surface density may be increased by laser treatment or infra-red rapid thermal annealing to form an impermeable skin on the surface.

### EXAMPLE 4

This example includes include a formulation for the preparation of an aluminosilicate layer. Other combinations are also satisfactory. An example application for such a layer is one in which a high dielectric constant is desired for a capacitor.

Step 1: Preparation of the Ink:

2.92 g fumed silica of ca. 25 mm mean particle size is blended with 6.0 g of 8% silica sol containing 8.0 g SiO₂/100 g sol derived from the acid hydrolysis of 41.66 g tetraethyl orthosilicate in 97 g propan-2-ol with 11.14 g 3.0 v % HNO₃ in H₂O.

7.0 g Al(NO3)₃.9H₂O and 2.0 g H₂O

20.0 g of a polymer gel is added, comprising 30 g hydroxypropyl cellulose B in 54 ml ethanol, 180 ml propan1:2 diol and 126 ml water.

11.0 g butoxyethanol and 2.6 g octanol are added and blend stirred until it appears homogeneous and translucent to visual inspection, for example as a thin layer under low power microscope examination.

Step 2: Screen Printing

The ink may be applied to the substrate using a patterned screen printing mask with, for example, a stainless steel 192 t.p.i mesh and 13 micrometer emulsion thickness. The mesh is ideally oriented at 45° to the frame axes.

Step 3: Drying and Firing

The coated substrates are dried on hot plates in clean room conditions, preferably in a laminar flow cabinet, at 65° C. for 20 minutes, followed by 20 minutes at 130° C. The warm substrates are transferred to an oven with a dean air atmosphere. For glass substrates the firing schedule is: ˜130° C. to 550° C. at 6° C. per minute, held at 2 hour at 550° C. and then slowly cooling to room temperature at 2 to 3° C. per minute. Films produced to this heat treatment schedule have densities approximately 50% of that of the fully dense material.

With more refractory substrates the maximum temperature may be increased and higher as-fired densities achieved. The local surface density may be increased by laser treatment or infra-red rapid thermal annealing to form an impermeable skin on the surface.

### EXAMPLE 5

This example includes include a formulation for the preparation of a high permittivity silica layer with TiO₂ additions. Other combinations are also satisfactory.

Step 1: Preparation of the Ink:

3.0 g nano-TiO₂ of approximately 25 nm mean particle size is blended with 12.0 g of commercially available silica sol containing 5% SiO₂.

3.28 g Dimethylformamide is added as a dispersion aid and drying control agent.

20.0 g of a polymer gel is added, comprising 30 g hydroxypropyl cellulose B in 54 ml ethanol, 180 ml propan1:2 diol and 126 ml water.

7.6 g butoxyethanol and 3.0 g octanol are added and the blend stirred until it appears homogeneous and translucent to visual inspection, for example as a thin layer under low power microscope examination.

Step 2: Screen Printing

The ink may be applied to the substrate using a patterned screen printing mask with, for example, a stainless steel 192 t.p.i mesh and 13 micrometer emulsion thickness. The mesh is ideally oriented at 45° to the frame axes.

Step 3: Drying and Firing

The coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. For glass substrates the firing schedule is: ˜130° C. to 550° C. at 6° C. per minute, held at 2 hour at 550° C. and then slowly cooling to room temperature at 2 to 3° C. per minute. Films produced to this heat treatment schedule have densities approximately 50%/o of that of the fully dense material.

With more refractory substrates the maximum temperature may be increased and higher as-fired densities achieved. The local surface density may be increased by laser treatment or infrared rapid thermal annealing to form an impermeable skin on the surface.

### EXAMPLE 6

This example includes include a formulation for the preparation of a resistive layer. Other combinations are also satisfactory.

This example provides as an aspect of the invention a method of preparing thick ceramic printable films with a range of resistivity by application of a precursor paste or ink which can be pyrolysed at temperatures equal to or greater than 400° C. to layer that is preferably up to 100 nm in thickness for a thin film or up to 6 microns for a thick film in a single print application.

A suitable ink to create such a layer comprises:
A: Colloidal ceramic nanoparticles of particle size 10 to 100 nm which may be composed of:
   A-1: simple or compound oxides, containing cations of one or more elements
   A-2: nitrides and oxynitrides
   A-3: borates, silicates or phosphates.
B: Soluble ceramic precursors composed of an oxide sol or a salt or organometallic complex soluble in the solvents used in the precursor.
C: Salts or organometallic compounds of one or more metallic elements which are soluble in the solvent systems used for the precursor and which, on firing to an oxide phase in air, give conductive properties to the resultant thick or thin film.
D: Polymer to control Theological properties.
E: Drying control agents.
F: Dispersion agents
G: Volatile solvents which, together with components from C above, control rheology and which are lost in the preliminary drying stage.

The ink is prepared in the following manner:

The ink is formulated from combinations of one or more items from A to G above, together with such processes as are necessary to obtain a homogeneous product. Typical processes are mixing with the aid of ultrasonic or high shear blenders, triple roll mills, ball mills or blade mills. If necessary this may be followed by vacuum or pressure filtration to remove undispersed aggregates.

The ink may be applied to the substrate using techniques such as screen printing, inkjet printing, wire roll bar, doctor blade coating, spraying or spin coating. The preferred method is screen printing to give uniform layers with a wet thickness of 10 to 30 micrometers.

The fugitive solvents are removed by initial gradual drying on a hot plate, IR lamp drying or warm air flow. Ideal drying temperatures to remove solvent without cracking are in the range 25° C. to 130° C.

The film is then cured by firing under controlled temperature rise to plateau temperature in the range 400° C. to 900° C., depending on the material and the substrate softening temperature, to obtain the finished layer as a ceramic sheet bonded to the substrate.

### EXAMPLE 7

This example includes a formulation for the preparation of a thick film conductive oxide layer. Other combinations are also satisfactory.

Step 1: Preparation of the ink:

The ink is prepared in two parts:

Part A:

2.95 g fumed silica of ca. 25 nm mean particle size is blended with 15.88 g silica sol containing 8.0 g SiO₂/100 g sol and derived from the acid hydrolysis of 41.66 g tetraethyl orthosilicate in 97 g propan-2-ol with 11.14 g 3.0 v/o HNO₃ in H₂O

3.0 g Dimethylformamide is added as a dispersion aid and drying control agent, converting the runny silica/sol blend into a stiff, translucent gel.

19.75 g of a polymer gel is added, comprising 30 g hydroxypropyl cellulose in 54 ml ethanol, 180 ml propan1:2 diol and 126 ml water. Mid-molecular weight grade of hydroxy propyl cellulose, B, is preferred.

7.5 g butoxyethanol and 1.7 g octanol are added and blend stirred until it appears homogeneous to visual inspection, e.g. as a thin layer under low power microscope examination.

Part B:

2.16 g La(NO₃)₃.6H₂O, 1.15 g Sr(NO₃)₂ 2H₂O and 9.0 g Co(NO₃)₂ 6H₂O are dissolved in 6.0 g H₂O and mixed with 10.0 g polymer gel as in Part A above, 2.0 g Butoxyethanol and 1.0 g octanol.

10.43 g Part A is combined with 5.18 g Part B and thoroughly mixed.

Step 2: Screen Printing

Ink may be applied to the substrate using a patterned screen printing mask with, for example, stainless steel 192 t.p.i. mesh and 13 micrometer emulsion. The mesh is ideally oriented at 45° to the frame axis.

Step 3: Drying and Firing

Coated substrates are dried on hot plates in dean room conditions, preferably in a laminar flow cabinet, at 65° C. for 20 minutes, followed by 20 minutes at 130° C. The warm substrates are transferred to an oven with a dean air atmosphere. For glass firing the firing schedule is ˜130° C. to 55° C. at 10° C./min, held for 1 hour at 550° C., and then slowly cooling to room temperature at 2-3° C. per minute.

### EXAMPLE 8

This example includes include a formulation for the preparation a 100 nm Ni(0.3)Co(0.7) oxide thin film. Other combinations are also satisfactory. Such layers may be used, for example, as a resisitive interconnect in a hybrid circuit board or a resistive layer in a display device.

Step 1: Preparation of the Ink:

0.2 g Al(NO₃)₃.9H₂O, 1.4 g CO(NO₃)₂.6H₂O and 0.7 g Ni(NO₃)₂.6H₂O are dissolved in 6.0 g H₂O

17.3 g of a polymer gel is added, comprising 30 g hydroxypropyl cellulose B in 54 ml ethanol, 180 ml propan-1:2-diol and 126 ml water.

8.9 g butoxyethanol and 2.4 g octanol are added and the blend stirred until it appears homogeneous to visual inspection, for example as a thin layer under low power microscope examination.

Step 2: Screen Printing

Ink may be applied to the substrate using a patterned screen printing mask with, for example, stainless steel 192 t.p.i. mesh and 13 micrometer emulsion. The mesh is ideally oriented at 45° to the frame axis.

Step 3: Drying and Firing

Coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. For glass firing, the firing schedule is 130° C. to 55° C. at 10° C./min, held for 1 hour at 550° C., and then slowly cooling to room temperature at 2-3° C. per minute.

This process yields 100 nm films with ca. 1 Mohms/sq. resistivity. Varying the proportion of Ni and Co nitrates in the mix will increase the resistivity as the Ni:Co ratio increases.

### EXAMPLE 9

This example includes a formulation for the preparation of an indium oxide thin film. Other combinations are also satisfactory. An example application for this layer is as a transparent conductive electrode e.g. in a photovoltaic solar cell, or for a transparent anode, e.g. in a plasma display panel or a field emission display.

Step 1: Preparation of the Ink:

1.7 g In(NO₃)₃.6H₂O is dissolved in 2.5 g H₂O and 2 g propan-2-ol and the solution filtered through a 0.2 micrometer filter.

15.0 g of a polymer gel is added, comprising 30 g hydroxypropyl cellulose B in 54 ml ethanol, 180 ml propan-1:2-diol and 126 ml water.

2.0 g of octanol is added.

Step 2: Screen Printing

Ink may be applied to the substrate using a patterned screen printing mask with, for example, stainless steel 192 t.p.i. mesh and 13 micrometer emulsion. The mesh is ideally oriented at 45° to the frame axis.

Step 3: Drying and Firing

Coated substrates are dried on hot plates in dean room conditions, preferably in a laminar flow cabinet, at 65° C. for 20 minutes, followed by 20 minutes at 130° C. The warm substrates are transferred to an oven with a clean air atmosphere. For glass firing the firing schedule is ˜130° C. to 55° C. at 10° C./min, held for 1 hour at 550° C., and then slowly cooling to room temperature at 2-3° C. per minute.

### EXAMPLE 10

This example includes a formulation for the preparation of a charge dissipation layer. Other combinations are also satisfactory.

Step 1: Preparation of the Ink:

0.2 g Al(NO₃)₃.9H₂O, 1.0 g Co(NO₃)₂.6H₂O and 1.0 g Ni(NO₃)₂.6H₂O are dissolved in 6.0 g H₂O

17.0 g of a polymer gel is added, comprising 30 g hydroxypropyl cellulose B in 54 ml ethanol, 180 ml propan-1:2-diol and 126 ml water.

8.0 g butoxyethanol and 2.4 g octanol are added and then blend stirred until it appears homogeneous to visual inspection, for example as a thin layer under low power microscope examination.

Step 2: Screen Printing

Ink may be applied to the substrate using a patterned screen printing mask with, for example, stainless steel 192 t.p.i mesh and 13 micrometer emulsion. The mesh is ideally oriented at 45° to the frame axis.

Step 3: Drying and Firing

Coated substrates are dried on hot plates in dean room conditions, preferably in a laminar flow cabinet, at 65° C. for 20 minutes, followed by 20 minutes at 130° C. The warm substrates are transferred to an oven with a clean air atmosphere. For glass firing the firing schedule is ˜130° C. to 55° C. at 10° C./min, held for 1 hour at 550° C., and then slowly cooling to room temperature at 2-3° C. per minute.

### EXAMPLE 11

This example includes a formulation for the preparation of a charge dissipation layer that contains iron oxide. Other combinations are also satisfactory.

Step 1: Preparation of the Ink:

52.8 g Fe(NO₃)₃.6H₂O is dissolved in 100.0 g H₂O—Solution A

2.2 g solution A is added to 40.0 g of a polymer gel, comprising 24 g hydroxypropyl cellulose B in 120 ml ethanol, 200 ml propan-1:2-diol and 105 ml water.

0.5 g of a silica sol is added containing 8.0 g SiO₂/100 g sol and derived from the acid hydrolysis of 41.66 g tetraethyl orthosilicate in 97 g propan-2-ol with 11.14 g 3.0 v % HNO₃ in H₂O.

1.5 g xylene and 1.5 g octanol are added and the blend stirred until it appears homogeneous to visual inspection, for example as a thin layer under low power microscope examination.

Step 2: Screen Printing

Ink may be applied to the substrate using a patterned screen printing mask with, for example, stainless steel 192 t.p.i. mesh and 13 micrometer emulsion. The mesh is ideally oriented at 45° to the frame axis.

Step 3: Drying and Firing

Coated substrates are dried on hot plates in clean room conditions, preferably in a laminar flow cabinet, at 65° C. for 20 minutes, followed by 20 minutes at 130° C. The warm substrates are transferred to an oven with a dean air atmosphere. For glass firing the firing schedule is ˜130° C. to 550° C. at 10° C./min, held for 1 hour at 550° C., and then slowly cooling to room temperature at 2-3° C. per minute.

### EXAMPLE 12

This example includes a formulation for the preparation of a thin silica barrier layer. Other combinations are also satisfactory. Such layers can be used, for example, to prevent the migration of elements from one layer to another in a device.

This example provides as an aspect of the invention a method of preparing thin printable SiO₂ films with an ink that can be pyrolysed at temperatures equal to or greater than 400° C. to give a layer preferably in the range 5 to 100 nm. The layer is preferably a substantially crack free, continuous layer of uniform composition.

This procedure gives 5 nm thick films. The thickness can be increased to give ˜100 nm by proportionate increase in the quantity of silica sol, Part A, added to the blend.

A suitable ink to create such layers comprises:
A: Soluble silica precursors composed of an oxide sol or organometallic complex soluble in the solvents used in the ink
B: polymer to control Theological properties
C: Drying control agents
D: Dispersion agents
E: volatile solvents which, together with components from B above, control rheology and which are lost in the preliminary drying stage.

The ink is formulated from combinations of one or more items from A to E above, together with such processes as are necessary to obtain a homogeneous product. Typical processes are mixing with the aid of ultrasonic or high shear blenders, triple roll mills, ball mills or blade mills, with vacuum or pressure filtration if necessary to remove undispersed aggregates.

The ink may be applied to a substrate using techniques such as screen printing, inkjet printing, K bar or doctor blade coating, spraying or spin coating. The preferred method is screen printing to give uniform layers with a wet thickness of 10 to 30 micrometers.

The fugitive solvents are removed by initial gradual drying on a hot plate, IR lamp drying or warm air flow. Recommended drying temperatures are in the range 25° C. to 130° C. to remove solvent without cracking.

The film is then cured by firing under controlled temperature rise to a plateau temperature in the range 400° C. to 900° C., depending on the material and the substrate softening temperature, to obtain the finished layer as a ceramic sheet bonded to the substrate.

Step 1: Preparation of the Ink:

The ink is prepared in 2 parts:

Part A

Silica sol containing 8.0 g SiO₂/100 g sol is derived from the acid hydrolysis of 41.66 g tetraethyl orthosilicate in 97 g propan-2-ol with 11.14 g 3.0 v % HNO₃ in H₂O.

Part B

Polymer gel is prepared from 30 g hydroxypropyl cellulose in 54 ml ethanol, 180 ml propan1:2 diol and 126 ml water. Hydroxy propyl cellulose B is preferred.

0.4 g silica sol (part A) is blended with 32 g polymer gel (Part B)

18 g butoxyethanol and 2.4 g octanol are added and the blend stirred until it appears homogeneous to visual inspection, e.g. as a thin layer under low power microscope examination.

Step 2: Screen Printing

The ink may be applied to the substrate using a patterned screen printing mask with, for example, stainless steel 325 t.p.i. mesh and 13 micrometer emulsion. The mesh is ideally oriented at 45° to the frame axis.

Step 3: Drying and Firing

The coated substrates area dried on hot plates in clean room conditions, preferably in a laminar flow cabinet, at 65° C. for 20 minutes, followed by 20 minutes at 130° C. The warm substrates are transferred to an oven with a clean air atmosphere. The firing schedule is ˜130° C. to 450° C. at 5-10° C./min, held for 1 hour at 450° C., and then slowly cooling to room temperature at 2-3° C. per minute.

### EXAMPLE 13

This example includes a formulation for the preparation of an alumina layer for use in, for example, a humidity sensor. Other combinations are also satisfactory.

This example provides as an aspect of the invention a method of preparing thin printable Al₂O₃ films with an ink that can be pyrolysed at temperatures equal to or greater than 400° C. to give a layer preferably with a thickness in the range 5 to 100 nm. The layer is preferably a substantially crack free, continuous layer of uniform composition.

A suitable ink to create such layers comprises:
A: Soluble precursors of alumina composed of an oxide sol, an aluminium salt or organometallic complex soluble in the solvents used in the ink.
B: Polymer to control theological properties.
C: Drying control agents.
D: Dispersion agents.
E: Vvolatile solvents which, together with components from B above, control rheology and which are lost in the preliminary drying stage.

The ink is formulated from combinations of one or more items from each of A to E above, together with such processes as are necessary to obtain a homogeneous product. Typical processes are mixing with the aid of ultrasonic or high shear blenders, triple roll mills, ball mills or blade mills, with vacuum or pressure filtration if necessary to remove undispersed aggregates.

The ink may be applied to a substrate using techniques such as screen printing, inkjet printing, wire roll bar, doctor blade coating, spraying or spin coating. The preferred method is screen printing to give uniform layers with a wet thickness of 10 to 30 micrometers.

The fugitive solvents are removed by initial gradual drying on a hot plate, IR lamp drying or warm air flow. Recommended drying temperatures are in the range 25° C. to 130° C. to remove solvent without cracking.

The film is then cured by firing under controlled temperature rise to plateau temperature in the range 400° C. to 900° C., depending on the material and the substrate softening temperature, to obtain the finished layer as a ceramic sheet bonded to the substrate.

One exemplary formulation for the preparation of a 25 nm thick alumina film is as follows although other combinations are also satisfactory.

Step 1: Preparation of the Ink:

1.0 g Al(NO 3)₃.9H₂O is dissolved in 5 g H₂O.

To this is added 20 g of a polymer gel prepared from 30 g hydroxypropyl cellulose in 54 ml ethanol, 180 ml propan1:2 diol and 126 ml water. Hydroxy propyl cellulose B is preferred.

10 g butoxyethanol and 1.5 g octanol are added and the blend stirred until it appears homogeneous to visual inspection, e.g. as a thin layer under low power microscope examination.

Step 2: Screen Printing

The ink may be applied to the substrate using a patterned screen printing mask with, for example, stainless steel 325 t.p.i. mesh and 13 micrometer emulsion. The mesh is ideally oriented at 45° to the frame axis.

Step 3: Drying and Firing

The coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. The firing schedule is −130° C. to 450° C. at 5-10° C./min, held for 1 hour at 450° C., and then slowly cooling to room temperature at 2-3° C. per minute.

### EXAMPLE 14

This example includes a formulation for the preparation of a phosphor layer for use in, for example, a flat lamp. Other combinations are also satisfactory.

This example provides as an aspect of the invention a method of preparing screen printable films of a particulate, inorganic, luminescent material or “phosphor” with an ink that can be pyrolysed at temperatures equal to or greater than 400° C. to give an adherent, translucent layer approximately 1 particle thick.

A suitable ink to create such layers comprises:
A: Phosphor in dry, free flowing powdered form, with particle size in region 2-10 micrometers, but ideally 3 to 4 micrometers.
B: Soluble silica precursors composed of an oxide sol or organometallic complex soluble in the solvents used in the ink
C: Polymer to control Theological properties
D: Drying control agents
E: Dispersion agents
F: volatile solvents which, together with components from B above, control rheology and which are lost in the preliminary drying stage.

The ink is formulated from combinations of one or more items from each of A to F above, together with such processes as are necessary to obtain a homogeneous product. Typical processes are mixing with the aid of ultrasonic or high shear blenders, triple roll mills, ball mills or blade mills, with filtration through silk screening cloth to remove aggregates greater than 10 micrometers in diameter.

The ink may be applied to a substrate using techniques such as screen printing, inkjet printing, K bar or doctor blade coating, spraying or spin coating. The preferred method is screen printing to give uniform layers with a wet thickness of 10 to 30 micrometers.

The fugitive solvents are removed by initial gradual drying on a hot plate, IR lamp drying or warm air flow. Recommended drying temperatures are in the range 25° C. to 130° C. to remove solvent without cracking.

The film is then cured by firing under controlled temperature rise to plateau temperature in the range 400° C. to 900° C., depending on the material and the substrate softening temperature, to obtain the finished layer as a ceramic sheet bonded to the substrate.

One exemplary formulation for the preparation of a P47 phosphor coating for a blue cathodoluminescent screen is as follows although other combinations are also satisfactory.

Step 1: Preparation of the Ink:

14.0 g phosphor powder with median particle size 4 micrometers is added to 10.0 g butoxyethanol

3.0 g of a commercial silica sol containing 15.0 g SiO₂/100 g sol is added.

To this is added 7.0 g of a polymer gel prepared from 30 g hydroxypropyl cellulose in 54 ml ethanol, 18 0 ml propan1:2 diol and 126 ml water. Mid-molecular weight grade of hydroxy propyl cellulose B is preferred.

The blend is stirred until it appears homogeneous to visual inspection, e.g. as a thin layer under low power microscope examination.

Step 2: Screen Printing

The ink may be applied to the substrate using a patterned screen printing mask with, for example, stainless steel 325 t.p.i. mesh and 13 micrometer emulsion. The mesh is ideally oriented at 45° to the frame axis.

Step 3: Drying and Firing

The coated substrates area dried on hot plates in clean room conditions, preferably in a laminar flow cabinet, at 65° C. for 20 minutes, followed by 20 minutes at 130° C. The warm substrates are transferred to an oven with a dean air atmosphere. The firing schedule is ˜130° C. to 450° C. at 5-10° C./min, held for 1 hour at 450° C., and then slowly cooling to room temperature at 2-3° C. per minute.

Inks may also be prepared using combinations of the following functional materials.

Thickening agents: Ethyl cellulose, hydroxyethyl cellulose, carboxymethyl cellulose, methylhydroxypropyl cellulose, hydroxypropyl cellulose, xanthan gum, guar gum.

Anti-foaming agents: Emulsions of organic polymers and organic metal-compounds for aqueous based inks (e.g. EFKA-2526, EFKA-2527); silicone free defoaming substances in alkylbenezene (e.g. EFKA-2720).

Levelling agents: Fluorocarbon modified polyacrylate in sec. butanol for both aqueous and non-aqueous inks (e.g. EFKA-3772); organically modified polysiloxane in isobutanol (e.g. EFKA-3030); solvent-free modified polysiloxane (e.g. EFKA-3580).

Wetting agents: Unsaturated polyamide and acid ester salt in xylene, n-butanol and monopropyleneglycol (e.g. EPKA-5044); anionic wetting agents of alkylol ammonium salts of a high molecular weight carboxylic acid in water (e.g. EFKA-5071).

Preservatives: phenol, formaldehyde.

Air-release agents: silica particles, silicones

Retarder: 1,2-propanediol, terpineol.

Dispersing agents: Modified polyurethane in butylacetate, methoxypropylacetate and sec. butanol (e.g. EFKA-4009); modified polyacrylate in methoxypropanol (EFKA-4530), polyethylene glycol mono(4-(1,1,3,3-tetramethylbutyl)phenyl) ether.

Methylhydroxypropyl cellulose and other thickeners at lower concentrations may also serve this function. In fact many additives may have multiple functionality.

EFKA products may be obtained from:
EFIA Additives by
Innovatielaan 11
8466 SN Nijehaske
The Netherlands

The above inks all have theological properties suitable for screen printing. Their typical Theological properties are illustrated by the exemplary flow curve shown in FIG. 4a. The Theological measurements were made using a Bohlin CV 120 rheometer using cone and plate geometry. FIG. 4b shows the clearly different theological properties of a conventional proprietary high resolution thick film printing paste measured on the same instrument.

Post-cure treatments such as gentle ultrasonic cleaning or tacky rollers may be used to remove any loose particles.

The flatness of the finished film is an important parameter, as it affects the ease by which subsequent structures can be built upon the layers. The best examples of the inks described herein produce layers with an average roughness of 8 nm with a root mean square value of 11 nm when measured using a Burleigh Horizon non-contact optical profilometer using a x10 Mirau objective.

### EXAMPLE 15

This example includes a formulation for the preparation of a charge dissipation layer with a sheet resistance of the order of 109 ohms/sq.—although the exact figure will depend on the quality of print and any reactions with the surface of the substrate. Other combinations are also satisfactory.

Step 1: Preparation of the Ink:

0.4 g AgNO₃ is dissolved in 3.0 g H₂O and 0.5 g concentrated nitric acid. 30.0 g of a polymer gel, comprising 30 g hydroxypropyl cellulose B in 54 ml ethanol, 180 ml propan-1:2-diol and 126 ml water, is added, with 15 g butoxyethanol and 3 g octanol.

8 g of a commercial SiO₂ sol containing ²⁴ g SiO₂/100 g sol is added, and the blend stirred until it appears homogeneous to visual inspection, for example as a thin layer under low power microscope examination.

Step 2: Screen Printing

The ink may be applied to the substrate using a patterned screen printing mask with, for example, stainless steel 192 t.p.i. mesh and 13 micrometer emulsion. The mesh is ideally oriented at 45° to the frame axis. Alternatively it may be applied by a drag bar or roller.

Step 3: Drying and Firing

Coated substrates are dried on hot plates in clean room conditions, preferably in a laminar flow cabinet, at 65° C. for 20 minutes, followed by 20 minutes at 130° C. The warm substrates are transferred to an oven with a clean air atmosphere. For glass firing the firing schedule is 130° C. to 55° C. at 10° C./min, held for 1 hour at 450° C., and then slowly cooling to room temperature at 2-3° C. per minute.

The operation and construction of such devices, which are only examples of many applications of embodiments of this invention, will readily be apparent to those skilled in the art. An important feature of preferred embodiments of the invention is the ability to print a pattern, thus enabling complex multi-layer structures, such as those required for displays, to be created at modest cost. In the context of this specification, printing means a process that places or forms an emitting material in a defined pattern. Examples of suitable processes to print these inks are (amongst others) screen printing or offset lithography. If patterning is not required techniques such as wire roll coating (K-coaters) or blade coating may also be used.

In the previous examples, one screen printer mesh size and one emulsion thickness has been commonly given as an example for printing the materials. This does not preclude the use of other screen printer meshes or emulsion thicknesses. Different parameters are useful for different feature sizes and definition requirements in the printed pattern. Another example of a mesh size that is useful in printing fine feature sizes of high aspect ratio (such as interconnects and associated layers) is 400 t.p.i. mesh with 13 micrometer emulsion. Another example is the use of a 325 t.p.i. mesh.

The above examples can also be formulated with light sensitive components to provide a photopatternable formulation. Examples of such components include photoinitiator compounds (such as azo compounds like 2-2′-azo-bis-isobutyrylnitrile and benzoyl peroxide), oligomers and photosensitisers. The ink can still be screen printed over the desired area, or indeed applied by the other methods outlined above. However, by exposing the dried but uncured film to ultraviolet radiation through a photomask, as used in standard photolithography, the irradiated areas are chemically altered so that they may be either more easily removed in a suitable solvent or are more difficult (due to chemical cross-linking) to remove in a suitable solvent. This is the same principle as used in a positive or negative photoresists, but because the ink is itself photosensitive, there is no requirement for the additional steps of using a photoresist to pattern the layer. A photopatternable ink of the above families has the advantage that finer features may be defined by the photopatterning process than achievable using the screen printer stencil. For example, a screen printing stencil may be used to define 30 micrometer features, but a photopatternable ink may be used to define sub 10 micrometer features.

An example of a multi-layer sensor device made using layers as disclosed herein is illustrated in FIG. 5. The use within these structures of some of the various functional materials disclosed herein is referenced by means of the example numbers used herein. The structure is formed of an insulating substrate 400 (usually ceramic), electrode tracks 401, printed active sensor layer such as aluminium oxide for a humidity sensor 402 (Example 13), and overlying electrode 403. The change in electric charge capacity of this cell varies with the local environmental humidity. This structure can be printed as a multitude of devices on a substrate which can then by diced up to give individual components.

Examples of field emission display devices made using layers as disclosed herein are illustrated in FIGS. 6a, 6b and 6c. The use within these structures of some of the various functional materials disclosed herein is referenced by mean of the example numbers used herein.

FIG. 6a shows an addressable gated cathode as might be used in a field emission display. The various process steps are described by the applicants in patents GB 2 330 687 and GB 2 355 338. The structure is formed of an insulating substrate 500 (usually glass), cathode tracks 501, printed emitter layer 502 (see, for example, GB 2 304 989, 2 332 089, 2 367 186), etch stop layer 503 (Example 1) overlaying the cathode tracks, gate insulator 504 (Examples 2, 3, 4) and gate tracks 505. The gate tracks and gate insulators are perforated with emitter cells 506. A negative bias on a selected cathode track and an associated positive bias on a gate track causes electrons 507 to be emitted towards an anode (not shown).

The electrode tracks in each layer may be merged to form a controllable but non-addressable electron source that would find application in numerous devices.

It is to be noted that, surprisingly, in contrast to the structures disclosed in GB 2.330 687, the etch stop layer 503 in this example is an insulator rather than a conductor, but nevertheless resists the fluorine chemistry typically used to etch the silica gate insulator. Since the etch stop layer 503 is an insulator, it need not be patterned like the cathode tracks 501. FIG. 7a is a view similar to FIG. 6a, but showing a non-patterned etch stop layer 703.

We have found that, surprisingly, with a suitable choice of insulator phase (e.g. alumina) in the field emission material, the etch stop layer 503 or 703 can be omitted entirely. FIG. 7b shows such an arrangement.

In another aspect, the invention provides a method of creating a field emission device, as disclosed in GB 2 330 687, but wherein the conductive etch-stop layer such as the layer 503 is an electrically insulating layer or omitted altogether.

FIG. 6b shows how the addressable structure 510 described above may joined with a glass fritt seal 513 to a transparent anode plate 511 having upon it a phosphor screen 512 (Example 14) upon an indium oxide conductive layer 514 (Example 9). The space 514 between the plates is evacuated, to form a display.

Although a monochrome display has been described, for ease of illustration and explanation, it will be readily understood by those skilled in the art that a corresponding arrangement with a three-part pixel may be used to produce a colour display.

FIG. 6c shows a flat lamp using one of the above-described materials. Such a lamp may be used to provide backlighting for liquid crystal displays, although this does not preclude other uses, such as room lighting.

The lamp comprises a cathode plate 520 upon which is deposited a conducting layer 521 and an emitting layer 522 (see, for example, GB 2 304 989, 2 332 089, 2 367 186). Resistive (ballast) layers (Example 6, 7, 8) as described in our other patent publications mentioned herein may be used to improve the uniformity of emission. A transparent anode plate 523 has upon it a conducting layer 524 (Example 9) and a phosphor layer 525 (Example 14). A ring of glass fritt 526 seals and spaces the two plates. The interspace 527 is evacuated.

Devices that embody the invention may be made in all sizes, large and small. This applies especially to displays, which may range from a single pixel device to a multi-pixel device, from miniature to macro-size displays.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of creating a layer of electrically insulating material in a thin-film structure, the method comprising the steps of coating a substrate in one pass with an ink having a major, fugitive component and at least one minor, non-fugitive component and treating the ink to expel said major component to leave said layer of electrically insulating material, wherein said layer of electrically insulating material has a thickness in the range 0.5 to 10 micrometres, and said ink contains non-fugitive colloidal ceramic nanoparticles having a size in the range 10 to 100 nanometres.

2. A method according to claim 1, wherein said nanoparticles comprise one or more simple or compound oxide, containing cations of one or more element.

3. A method according to claim 2, wherein said one or more element is selected from the group comprising nitrides, oxynitrides, borates, silicates and phosphates.

4. A method according to claim 1, wherein said ink comprises an insulator precursor selected from the group comprising sols, organometallics and organic compounds containing non-metallic elements.

5. A method according to claim 4, wherein said ink comprises an insulator precursor selected from the group comprising silica sol, polysiloxanes, silsequioxane polymers, -chloroethylsilsesquioxane, hydrogensilsequioxane, acetoxysilsesquioxane and H₃BO₃.

6. A method of creating a process control layer of a material in a thin-film structure, the method comprising the steps of coating a substrate in one pass with an ink having a major, fugitive component and at least one minor, non-fugitive component and treating the ink to expel said major component to leave said layer of material.

7. A method according to claim 6, wherein said process control layer is an etch stop layer.

8. A method according to claim 7, wherein said etch stop layer is adapted to resist fluorine chemistry etching.

9. A method according to claim 7, wherein said ink comprises a precursor for the process control layer which comprises at least one selected from the group comprising soluble compounds of the transition metals and sols of transition metal oxides.

10. A method according to claim 9, wherein said transition metals have an atomic number in the range 21 to 30.

11. A method according to claim 10, wherein said transition metal is chromium.

12. A method according to claim 11, wherein said precursor comprises Cr(NO₃)₃.9H₂O.

13. A method according to claim 6, wherein said process control layer is a barrier layer.

14. A method according to claim 13, wherein said ink comprises a precursor for said layer that is selected from the group comprising silica sol, alumina sols, titania sol, alumina sol plus a soluble phosphate, alumina sol plus a soluble organophosphate, polysiloxanes, silsequioxane polymers, -chloroethylsilsesquioxane, hydrogensilsequioxane and acetoxysilsesquioxane.

15. A method of creating an optically emissive layer of material in a thin-film structure, the method comprising the steps of coating a substrate in one pass with an ink having a major, fugitive component and at least one minor, non-fugitive component and treating the ink to expel said major component to leave said optically emissive layer of material.

16. A method according to claim 15, wherein said optically emissive layer of material comprises a phosphor.

17. A method according to claim 16, wherein said ink contains phosphor that has been added in dry, free-flowing powdered form, with a particle size in the range 1 to 10 micrometers.

18. A method according to claim 17, wherein said particle size is in the range 3 to 5 micrometers.

19. A method according to claim 15, wherein said ink comprises a soluble silica precursor comprising an oxide sol or organometallic complex soluble in the solvents used in the ink.

20. A method according to claim 1, wherein the step of treating the ink comprises subjecting the ink to ultra-violet radiation.

21. A method of creating a layer of a material of predetermined electrical conductivity in a thin-film structure, the method comprising the steps of coating a substrate in one pass with an ink having a major, fugitive component and at least one minor, non-fugitive component and treating the ink to expel said major component to leave said layer of material, wherein said minor, non-fugitive component comprises one or more soluble ceramic precursor.

22. A method according to claim 21, wherein said minor, non-fugitive component comprises colloidal ceramic nanoparticles having a size in the range 10 to 100 nanometres.

23. A method according to claim 21, wherein said soluble ceramic precursor comprises one or more soluble compound of a metallic element that is a transition metal, rare earth element or main group element.

24. A method according to claim 23, wherein said one or more soluble compound is selected from the group comprising La(NO₃)₃.6H₂O, Sr(NO₃)₂.2H₂O, Co(NO₃)₂.6H₂O, Al(NO₃)₃.9H₂O, Co(NO₃)₂.6H 20, Ni(NO₃)₂.6H₂O, In(NO₃)₃.6H₂O, Fe(NO₃)₃.6H₂O and AgNO₃.

25. A method according to claim 21, wherein said soluble ceramic precursor comprises one selected from the group comprising sols, organometallics and organic compounds containing non-metallic elements.

26. A method according to claim 1, wherein the step of treating the ink comprises pyrolising the ink.

27. A method according to claim 26, wherein said ink is pyrolised at a temperature that is equal to or greater than 400C.

28. A method according to claim 1, wherein the layer is a continuous layer.

29. A method according to claim 1, wherein the layer is substantially crack-free.

30. A method according to claim 1, wherein the layer is of uniform composition.

31. A method according to claim 1, wherein the layer is of a compound material.

32. A method according to claim 1, wherein the layer has a composite structure.

33. A method according to claim 1, wherein said ink contains at least one additive to control the rheology of the ink.

34. A method according to claim 33, wherein said at least one additive includes at least one thickening agent.

35. A method according to claim 34, wherein said thickening agent comprises a fugitive soluble organic polymer.

36. A method according to claim 35, wherein said fugitive soluble organic polymer is selected from the group comprising poly(vinyl) alcohol; ethyl cellulose; hydroxyethyl cellulose; carboxymethyl cellulose; methylhydroxypropyl cellulose; hydroxypropyl cellulose; xanthan gum; and guar gum.

37. A method according to claim 34, wherein said thickening agent comprises a non-fugitive material.

38. A method according to claim 37, wherein said non-fugitive material is selected from the group comprising fumed silica and Laponite.

39. A method according to claim 33, wherein said ink comprises at least one further additive to control further properties of the ink.

40. A method according to claim 39, wherein said at least one further additive comprises at least one of an anti-foaming agent; a levelling agent; a wetting agent; a preservative; an air-release agent; a retarder; and a dispersing agent.

41. A method according to claim 40, wherein said anti-foaming agent is a fugitive material.

42. A method according to claim 41, wherein said fugitive material is selected from the group comprising butyl cellosolve; n-octanol; emulsions of organic polymers and organic metal-compounds; and silicone-free defoaming substances in alkylbenezene.

43. A method according to claim 40, wherein said anti-foaming agent is a non-fugitive material.

44. A method according to claim 41, wherein said non-fugitive material comprises a silicone.

45. A method according to claim 40, wherein said dispersing agent is selected from the group comprising poly(vinyl) alcohol; modified polyurethane in butylacetate, methoxypropylacetate and sec. butanol; modified polyacrylate in meythoxypropanol; polyethylene glycol mono(4-(1,1,3,3-tetramethylbutyl)phenyl)ether; and mineral oils.

46. A method according to claim 45, wherein said dispersing agent comprises a silicone oil.

47. A method according to claim 40, wherein said at least one further additive comprises at least one dispersing agent and at least one said minor component has an affinity for that dispersing agent.

48. A method according claim 40, wherein said levelling agent is selected from the group comprising poly(vinyl) alcohol; fluorocarbon modified polyacrylate in sec. butanol; organically modified polysiloxane in isobutanol; and solvent-free modified polysiloxane.

49. A method according to claim 40, wherein said wetting agent is selected from the group comprising unsaturated polyamide and acid ester salt in xylene, n-butanol and monpropylenegylcol; and alkylol ammonium salt of a high molecular weight carboxylic acid in water.

50. A method according to claim 40, wherein said preservative is selected from the group comprising phenols and formaldehydes.

51. A method according to claim 40, wherein said air-release agent is selected from the group comprising silica particles and silicones.

52. A method according to claim 40, wherein said retarder is selected from the group comprising 1,2-propanediol and terpineol.

53. A method according to claim 1, wherein said coating step comprises screen printing.

54. A method according to claim 1, wherein said coating step comprises ink-jet printing.

55. A method according to claim 1, wherein said coating step comprises a step of printing selected from the group comprising offset lithography; pad printing; table coating and slot printing.

56. (canceled)

57. A thin-film structure that has been created by a method according to claim 1.

58. An optical device incorporating a thin-film structure according to claim 57.

59. A sensing device incorporating a thin-film structure according to claim 57.

60. An electronic device incorporating a thin-film structure according to claim 57.

61. An electronic device according to claim 60, being a field emission device.

62. An electronic device according to claim 61, comprising a plasma reactor, corona discharge device, silent discharge device, ozoniser, an electron source, electron gun, electron device, x-ray tube, vacuum gauge, gas filled device or ion thruster.
